(19) United States
(12) Patent Application Publication
(10) Pub. No.: US 2022/0335794 A1
(43) Pub. Date: Oct. 20, 2022

(54) SECURITY DEVICE AND SYSTEM FOR SECURING PHYSICAL OBJECTS

(71) Applicant: Royce Newcomb, Fresno, CA (US)

(72) Inventor: Royce Newcomb, Fresno, CA (US)

(21) Appl. No.: 17/235,831

(22) Filed: Apr. 20, 2021

(51) Int. Cl. G08B 13/14; H04N 7/18; G06K 7/10; G06K 7/14; G06Q 10/08; G07C 9/10

(52) U.S. Cl. CPC G08B 13/1445; H04N 7/188; G06K 7/10297; G06K 7/1413; G06K 7/1417; G06Q 10/0832; G07C 9/10; G08B 13/248

(57) ABSTRACT

A security device includes a memory device including instructions. At least one processor is configured for executing the instructions to: receive images of at least one physical object from at least one camera connected to the at least one processor, receive an indication from at least one security tether indicating movement of the at least one physical object, and provide an alert based on the indication of movement of the at least one physical object.

### FIELD

The present embodiments relate to security of physical objects, and in more particular, to security of physical objects and delivered objects by a security device and system.

### BACKGROUND

Package or object delivery is not only convenient, but prevalently used by many people using the Internet for purchases. Unfortunately, one issue with deliveries is theft of one or more delivered items. Many people use security cameras to help ward off package theft and also as evidence, albeit usually after the theft occurred.

### SUMMARY

Some embodiments provide a security device that includes a memory device including instructions. At least one processor is configured for executing the instructions to: receive images of at least one physical object from at least one camera connected to the at least one processor, receive an indication from at least one security tether indicating movement of the at least one physical object, and provide an alert based on the indication of movement of the at least one physical object.

One or more embodiments provide a security device system that includes a security device comprising: a first memory device including first instructions. A first processor is configured for executing the first instructions to: receive images of the at least one physical object from at least one camera coupled to the first processor, receive an indication from at least one security tether indicating movement of the at least one physical object, and provide an alert based on the indication of movement of the at least one physical objects. The system further includes a customer interface comprising: a second memory device including second instructions, and a second processor configured for executing the second instructions to: receive delivery details information, retrieve customer identification information, process the delivery details and customer identification information, and communicate the delivery details and the customer identification information through a first network to the security device and to a server.

### BRIEF DESCRIPTION OF THE DRAWINGS

The accompanying figures, which are incorporated herein, form part of the specification and illustrate one or more embodiments. Together with the description, the figures further explain the principles of the embodiments and to enable a person skilled in the relevant arts to make and use the embodiments.

FIG. 1 illustrates a block diagram of a system including a security device, according to one or more embodiments.

FIG. 2 illustrates a block diagram of another system including a security device, according to one or more embodiments.

FIG. 3 illustrates a block diagram of an embodiment of a system for security of multiple packages, according to one or more embodiments.

FIG. 4A shows a side perspective view of an example embodiment of the security device, according to one or more embodiments.

FIG. 4B shows a bottom perspective view of an example embodiment of the security device, according to one or more embodiments.

FIG. 4C shows a side perspective view of the security device showing an example user interface display, according to one or more embodiments.

FIG. 5 shows an example process for processing and transmitting data from a customer interface to both a security device and a server, according to one or more embodiments.

FIG. 6 shows an example embodiment of a process for processing and transmitting data from a server to both a third-party server and a customer interface, according to one or more embodiments.

FIG. 7 shows an example embodiment of a process for processing and transmitting data from a security device to both a delivery person and a customer interface, according to one or more embodiments.

FIG. 8 is a network architecture of a system for security processing, according to one or more embodiments.

FIG. 9 shows a representative hardware system environment associated with a user device and/or server, according to one or more embodiments.

FIG. 10 is a block diagram illustrating a distributed system that may be employed for security processing, according to one or more embodiments.

Although the specific features of the embodiments are shown in some drawings and not in others. This is done for convenience only, as each feature may be combined with any or all the other features in accordance with the embodiments herein.

### DETAILED DESCRIPTION

In the following detailed description, a reference is made to the accompanying drawings that form a part hereof, and in which the specific embodiments that may be practiced is shown by way of illustration. These embodiments are described in enough detail to enable those skilled in the art to practice the embodiments and it is to be understood that the logical, mechanical, and other changes may be made without departing from the scope of the embodiments. The following detailed description is therefore not to be taken in a limiting sense.

The following discussion is directed to various embodiments of the present disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various terms are used to refer to particular system components. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct communication between two or more elements, whether or not those elements are in physical contact with one another. Thus, if a first device couples to a second device, that connection may be through a direct connection or through an indirect connection via other devices and connections. The coupling can occur through two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely.

The terminology used herein is for the purpose of describing particular example embodiments only and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Various functions described below can be implemented or supported by one or more computer or microcontroller programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code including but not limited to source code, object code, and executable code. The phrase “computer readable medium” includes any type of medium capable of being accessed by a computer or microcontroller, such as read only memory (ROM), random access memory (RAM), a hard disk drive, a compact disc (CD), a digital video disc (DVD), or any other type of memory. A “non-transitory” computer or microcontroller readable medium excludes wired, wireless, optical, or other communication links that transport transitory electrical or other signals. A non-transitory computer or microcontroller readable medium includes media where data can be permanently stored and media where data can be stored and later overwritten, such as a rewritable optical disc or an erasable memory device.

In some embodiments, a security (delivery, package, object) device comprised of a microcontroller unit, a communication module, data storage memory, package detection system, and user interface provides data transfer through an Internet cloud based connection to both a customer interface device as well as a separate server (physical or cloud-based). The security device processes and stores the data/information and has access to the transferred data and other data stored on the physical server and customer interface device. The data transfer may include one or more planned or unplanned deliveries of a package or packages or any physical object. The data transfer may also include information regarding the actual delivery or deliveries of a package or packages or any type of physical object. The data transfer may also include an indication of unauthorized movement of the package or packages or any physical object. In one example embodiment, the data transfer includes an indication of the unauthorized movement of a bicycle, a bench, a potted plant, a statue, a vehicle (car, boat, motorcycle, camper, trailer, off-road vehicle, etc.) or some other decorative object on the porch of a location where the security device is located, or using a remote wireless camera device, an object remote from the security device. The data transfer may also include unauthorized movement of a gate, door or other entry way where the security device is located. The data transfer may also include audio and video information. The data transfer may occur not only between the security device and a customer interface device or physical server, but also between the customer interface device and the physical server through an Internet cloud-based connection, as well as, between the physical server through the Internet cloud-based connection to third-party interface devices or third-party physical servers.

The embodiments relate to item delivery and physical object security systems. Some embodiments provide a security device that includes a memory device including instructions. At least one processor is configured for executing the instructions to: receive images of at least one physical object from at least one camera connected to the at least one processor, receive an indication from at least one security tether indicating movement of the at least one physical object, and provide an alert based on the indication of movement of the at least one physical object.

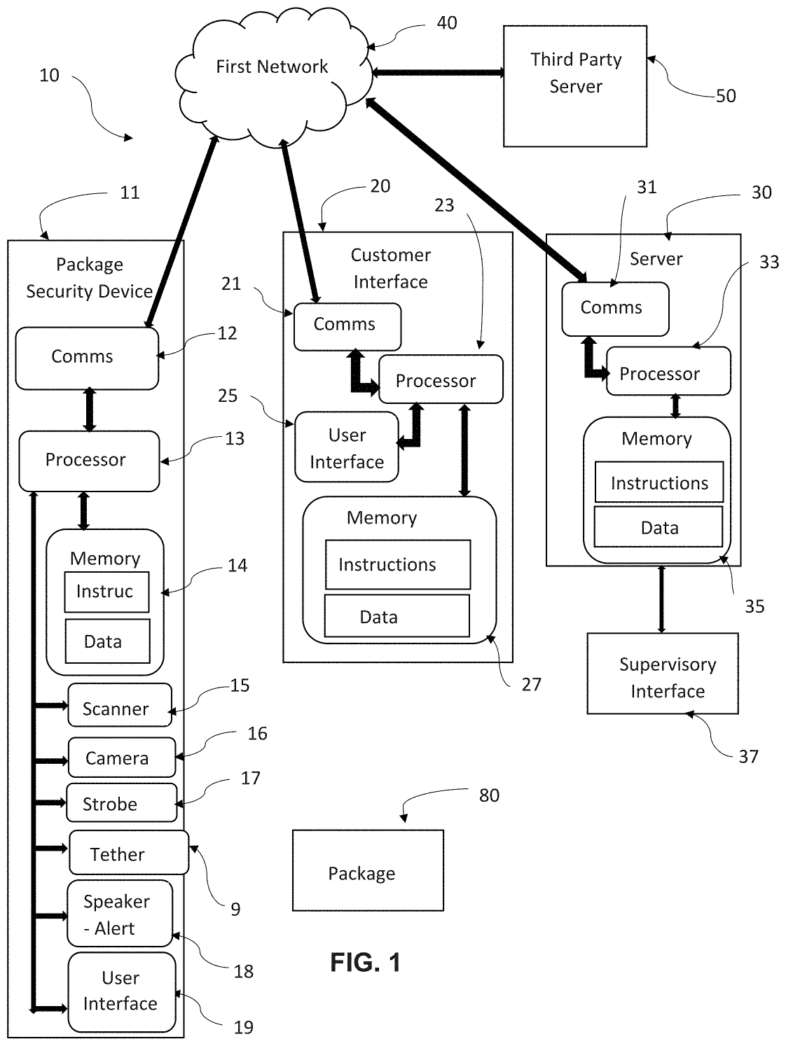

FIG. 1 illustrates a block diagram of a system 10 including a (delivery, package, object) security device 11, according to one or more embodiments. In some embodiments, the security system 10, hereinafter referred to as “the system,” assists in securing one or more packages 80. The security device 11 includes one or more communication devices or modules (or comms) 12 that transfers data via a first network 40 (e.g., the Internet, a local area network (LAN), a wide area network (WAN), a private network, etc. The data may be transferred via Wi-Fi, BLUETOOTH®, ZIGBEE®, Near-Field Communications (NFC), cellular data network, etc. The security device 11 further includes one or more processor devices 13, such as a microprocessor, computer device, microcontroller, etc., that is/are configured to receive and process data from the communication device 12 as well as to receive data from a variety of subsystems, including but not limited to a scanner 15, one or more cameras 16, a user interface 19 and one or more tethers 9 (physical, virtual, or both). The security device 11 also includes a memory storage device or module 14 (e.g., read-only memory (ROM), flash memory, dynamic random access memory (DRAM) such as synchronous DRAM (SDRAM)), a static memory (e.g., flash memory, static random access memory (SRAM), etc.) for storing data and instructions for performing various actions of the security device 11 for execution by the one or more processor devices 13.

In one or more embodiments, the security device 11 may be powered by a direct line (wired), with one or more disposable batteries, with one or more rechargeable batteries that are either removed from the security device 11 and placed in a charger, or a charger may be plugged into the security device 11 to recharge the one or more batteries. In some embodiments, upon removal of the one or more batteries from the security device 11 for recharging, another battery or second set of batteries may be supplied to continue powering the security device 11 during recharging of the initial one or more batteries. The security device 11 may also be configured with a solar electric panel(s) or solar cell that converts light into electricity to recharge the one or more batteries. The scanner 15 may be a bar code reader, a quick response (QR) code scanner, any similar type of code scanning device, a radio frequency identification (RFID) receiver/transceiver, etc. The scanner 15 is configured to read a code included on a shipping label of a delivery, such as on the one or more packages 80 (e.g., any type or sized delivery box, package, etc.), or receive an RFID attached/embedded for the one or more packages 80. The one or more cameras 16 may include one or more: still picture cameras, video cameras, etc. In some embodiments, the one or more cameras 16 may include a portable camera device that communicates with the comms 12 to provide data and information to capture remote images of a physical object or area. In some embodiments, the one or more cameras 16 are configured to capture images in the area adjacent the security device 11, particularly pictures/photos of the one or more packages 80 and anyone or device (e.g., delivery vehicle, such as a drone, wireless controlled vehicle, etc.) delivering or retrieving one or more packages 80.

In one or more embodiments, the user interface 19 may be in the form of a video display (e.g., a liquid crystal display (LCD) or a cathode ray tube (CRT)), a touch display (or resistive digitizer), one or more input devices (e.g., a keyboard and/or a mouse), one or more speaker devices, one or more microphones (e.g., a microphone), a natural language understanding (NLU) or natural language processing (NLP) device, gesture recognition device, etc. In one illustrative example, the customer interface 20 can be both a display(s) and input device(s) that are combined into a single component or device (e.g., an LCD touch screen). The user interface 19 can also be comprised of a button or similar device that is wired to ring a bell such as a doorbell for the address where the security device 11 is installed. In some embodiments, the one or more tethers 9 may be a physical tether device, a virtual tether target or zone, or both. A physical type of tether 9 is described in more detail below. A virtual tether 9 may be one or more visual light cameras, infrared light cameras, motion sensors, depth cameras (e.g., MICROSOFT® AZURE®), portable cameras, etc., or any combination thereof. In some embodiments, the virtual tether 9 may include use of light pulses, heat or thermal measurements, radio waves, etc., to detect motion. Using the one or more cameras 16, Passive infrared (PIR) sensors may be employed to monitor for ambient heat that is emitted by people, animals, etc. A PIR sensor detects movement of warm “objects” and/or a temperature differential between the object and the background scene. In some embodiments, the sensed differential may be used to signal the one or more cameras 16 to commence recording and an alert (e.g., via an app on a smart device (e.g., smartphone, computing pad, etc.), email, text message, cellular message, a wireless remote device (e.g., a fob, remote control, etc.) may be sent to the user. In some embodiments, computer vision (CV) may be employed for virtual tether 9. Computer vision uses software of the one or more cameras 16 for analyzing sequential frames of a live video feed for differences, and registers a motion event when a large enough change is detected. In one embodiment, a significant change in pixels over short periods of time are used for comparison to the longer term average to determine that something may have occurred. In another embodiment, CV may track groups of pixels and identify directional patterns, e.g., there was a particular dot one frame ago, but now there is the dot and one pixel to the left (e.g., and analysis may be employed to recognize moving objects). CV attempts to detect motion and possibly determine the shape of the object that moved (e.g., for comparison to known shapes or outlines). In some embodiments, advanced methods may be added to classify the moving object, (e.g., a person, an animal, a vehicle, a flag moving, etc.) in order to determine which detection signals are important to the user and which are irrelevant and should be ignored (e.g., animals, flags, trees, etc.). Whether the tether 9 is virtual or physical, it detects unauthorized movement of the one or more packages 80.

In some embodiments, the security device 11 may be configured with one or more strobe or visible alerts 17, such as light emitting diodes (LEDs) of any color, combination of colors or selected colors, strobe lights, etc., as well as one or more speaker or audible alerts 18 (e.g., transducer, loudspeaker, an alarm bell, etc.). The visible alerts 17 and audible alerts 18 are connected to the one or more processor devices 13 such that the one or more processor devices 13 activate the audible alerts 18 and visible alerts 17 upon the tether 9 detecting unauthorized movement of the package (or other physical objects) 80, and sends the information or data to the one or more processor devices 13. The one or more processor devices 13 may also activate the one or more cameras 16 to record the unauthorized movement of the one or more packages 80. The visible alerts 17 and audible alerts 18 may be configured to activate at a very high level of light and sound when the one or more tethers 9 detect unauthorized movement of the one or more packages or other physical objects 80 in order to both alert the owner (or authorized person or robotic device) of the security device 11 of the unauthorized movement, as well as to alarm, scare off or dissuade the person or device that is causing the unauthorized movement. The visible alerts 17 and audible alerts 18 may be configured to activate at a low level of light and sound when the security device 11 receives information of a pending delivery from a customer interface 20 or a server 30 as described herein in order to provide visible and audible guidance to the delivery person or device and to ensure a timely and accurate delivery.

In one or more embodiments, the system 10 includes a customer interface 20 including one or more communication devices or modules (or comms) 21 configured to send commands to the security device 11, and receive and send data (or information) related to the system 10. The customer interface 20 may include one or more processor devices or modules 23 such as one or more microprocessors, computers, microcontrollers, etc., that are configured to receive data and process data from the comms 21 as well as from a machine-readable storage memory 27 (e.g., ROM, flash memory, DRAM, SDRAM), a static memory (e.g., flash memory, SRAM), etc.). The memory 35 may include both instructions and data. The one or more communication modules 31 are also configured for transferring data to and from the server 30.

In one or more embodiments, the supervisory interface 37 may also include a user interface 25, which may be in the form of a video display (e.g., an LCD or CRT), a touch display (or resistive digitizer), one or more input devices (e.g., a keyboard and/or a mouse), one or more speaker devices, one or more microphones (e.g., a microphone), an NLU/NLP device, gesture recognition device, etc. In one illustrative example, the customer interface 20 may be both a display(s) and input device(s) that are combined into a single component or device (e.g., an LCD touch screen, etc.). The customer interface 20 may be a personal computer (PC), a tablet computer, a wearable (e.g., wristband, pendant, etc.), a set-top box (STB), a personal Digital Assistant (PDA), a mobile phone, a camera, a video camera, or any device capable of executing a set of instructions (sequential or otherwise) that specify actions to be taken by that device. The customer interface 20 may be powered by a direct line (wired), with one or more disposable batteries, one or more rechargeable batteries, etc.

In some embodiments, the system 10 includes a server 30 that may take the form of a distributed and/or virtualized computer or computers. The server 30 includes a first communication interface (or comms) 31 configured to communicate with the customer interface 20 and the security device 11 via the first network 40. In some embodiments, the first network 40 may include wired and/or wireless network connections. The server 30 includes a one or more processor devices 33 and a one or more machine-readable storage memory devices 35, which may be referred to as a “memory,” that stores instructions for performing the various actions of the server 30 for execution by the one or more processor devices 33. The one or more processor devices 33 represent one or more general-purpose processing devices such as a microprocessor, microcontroller, CPU, or the like. On one embodiment, the one or more processor devices 33 may be a complex instruction set computing (CISC) microprocessor, reduced instruction set computing (RISC) microprocessor, very long instruction word (VLIW) microprocessor, a processor implementing other instruction sets or processors implementing a combination of instruction sets, etc. In some embodiments, the one or more processor devices 33 may also be one or more special-purpose processing devices such as an application specific integrated circuit (ASIC), a field programmable gate array (FPGA), a digital signal processor (DSP), network processor, etc. The one or more processor devices 33 execute instructions for performing any of the operations and processing discussed herein. The memory 35 may take the form of any type of machine-readable storage memory (e.g., ROM, flash memory, DRAM, SDRAM, a static memory (e.g., flash memory, SRAM, etc.), and a data storage device, which communicate with each other via a bus. While the memory 35 is shown in the illustrative examples to be a single medium, the term “memory” should be taken to include a single medium or multiple media (e.g., a centralized or distributed database, and/or associated caches and servers) that store the one or more sets of instructions. The term “memory” shall also be taken to include any medium that is capable of storing, encoding or carrying a set of instructions for execution by the machine and that cause the machine to perform any one or more of the methodologies of the present disclosure. The term “memory” shall accordingly be taken to further include, but not be limited to, solid-state memories, optical media, magnetic media, etc.

In some embodiments, the server 30 may include one or more servers 30 that form a distributed computing architecture. Each of the servers 30 may include one or more processing devices, memory devices, data storage, and/or network interface cards. The servers 30 may be in communication with one another via any suitable communication protocol. In one or more embodiments, the server 30 may include a supervisory interface 37. The supervisory interface 37 also may include a video display (e.g., an LCD, CRT, etc., one or more input devices (e.g., a keyboard and/or a mouse)), and one or more speakers or equivalent. In one illustrative example, the video display and the input device(s) may be combined into a single component or device (e.g., an LCD touch screen, etc.). The supervisory interface 37 may be used to upload information to the memory 35 or to retrieve data from the memory 35. The supervisory interface 37 may be used to update or modify instructions stored in the memory 35 executed by the one or more processor devices 33 or to review instructions previously executed by one or more processor devices 33 that have been stored in the memory 35.

In one or more embodiments, the system 10 may be connected via the first network 40 to a third-party server 50. The first network 40 may be a public network (e.g., connected to the Internet via wired (e.g., Ethernet, etc.) or wireless (Wi-Fi, etc.)), a private network (e.g., a LAN, WAN, WLAN, etc.), or a combination thereof. The third-party server 50 may be configured to conduct a variety of processes including, but not limited to, receiving an address and delivery instructions associated with the security device 11 on a mapping database of the third-party server 50. For example, in one embodiment the third-party server 50 may be a commercially available mapping system that is commonly used by consumers and businesses to locate an address. In another embodiment, the third-party server 50 may be a private mapping system that is commonly used by a business to allow their employees to locate an address. These businesses may include, but are not limited to, a delivery service, a car share service, a food delivery service (e.g., from a restaurant, a convenient store, a supermarket, etc.), a car ride service, a document delivery service, mail delivery, an emergency service such as the police or sheriff's department, the fire department, an ambulance service, etc. It can be appreciated that using the system 10 to send an address and delivery instructions associated with the security device 11 may be very helpful in enabling business services, and even friends and family of the customer or business owner at that address in physically locating the address and delivering a package 80 to that location in a secure manner. This may be particularly beneficial in ensure timely, accurate, and secure delivery in locations that are not easily identified and distinct such as, but not limited to, apartment buildings, shopping centers, gated complexes, rural areas, etc.

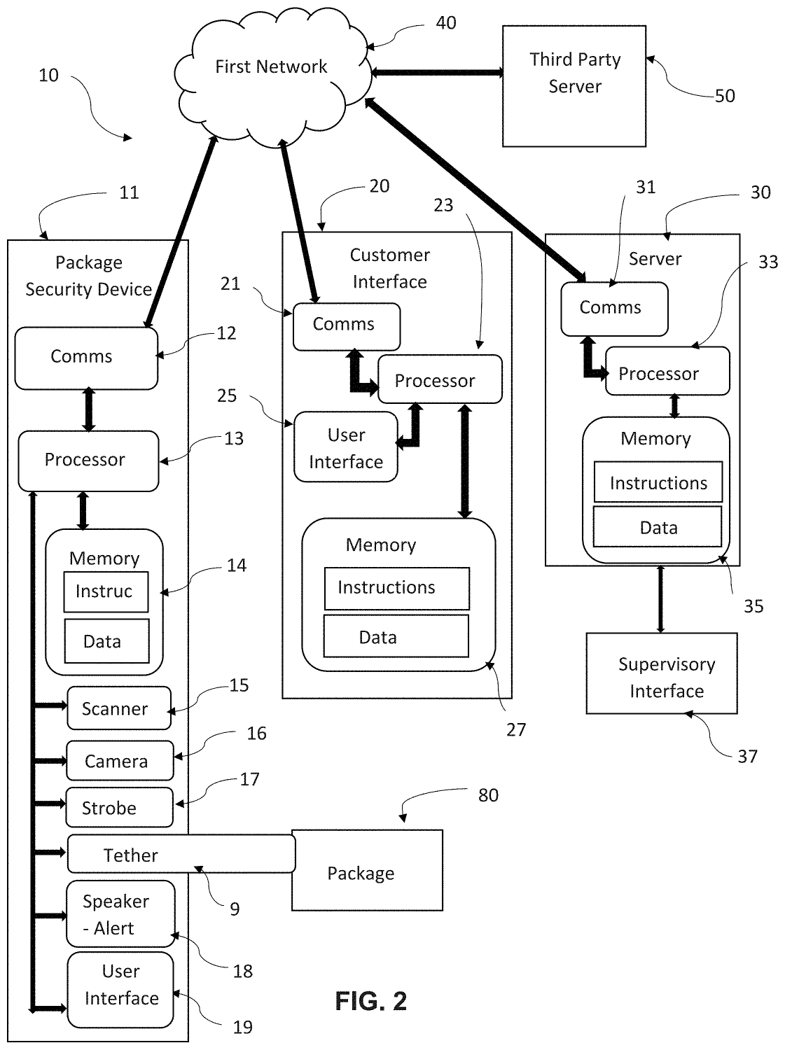

FIG. 2 illustrates a block diagram of another system 10 including the security device 11, according to one or more embodiments. For one or more embodiments, the system 10 has all the elements as described above regarding the system 10 of FIG. 1. In one example embodiment, the tether 9 is a physical tether that extends from the security device 11 and attaches to the package 80. In some embodiments, the physical tether 9 includes a retractable cable with a package attachment element at one end and attachment to the security device 11 at the other end. In one embodiment, the retractable cable is replaceable due to normal wear, for another cable in another color, a longer cable, etc. In one or more embodiments, the tether 9 can be attached to the package 80 by way of a clip at the end of the tether 9 that can grab a hold of a portion of the package 80. In other embodiments, the physical tether 9 may also be attached to the package 80 by other elements located at the end of the tether 9 including, but not limited to, an adhesive surface, a barbed spike, a magnet (e.g., a ferrite magnet, Neodymium magnet, etc.) a set of magnets, a hook device, a net or similar element that wraps around all or a portion of the package 80, etc. Any one of these or other elements may be used to secure the tether 9 to the package 80. The package attachment may be configured with a motion sensor, an accelerometer sensor, a gyroscope, or a combination thereof. Any of these types of sensors may include internal wires to enable the physical tether 9 to send data/information to the one or more processor devices 13 regarding unauthorized movement of the package 80 in order to set off the visible alerts 17, audible alerts 18, and or the one or more cameras 16 in order to deter the unauthorized movement and secure the package 80. In addition, the sensor(s) in the package attachment may be wirelessly connected to the one or more processor devices 13 to send/transmit data, information or a combination thereof regarding unauthorized movement of the package 80 or the tether 9 itself.

In some embodiments, the physical tether 9 may be a mat, pad or platform that is connected to the security device 11 either by a wired and/or wireless network connections such as Wi-Fi, BLUETOOTH®, ZIGBEE®, NFC, cellular data network, etc. The tether 9 as a mat, pad or platform may rest on any flat (or mostly flat) surface and detect the weight or mass of the package 80 that has been delivered and detect changes in the weight or mass of the package 80 after delivery and send that data or information to the one or more processor devices 13 in order to activate or set off the visible alerts 17, audible alerts 18, and or one or more cameras 16 to deter the unauthorized movement and secure the package 80.

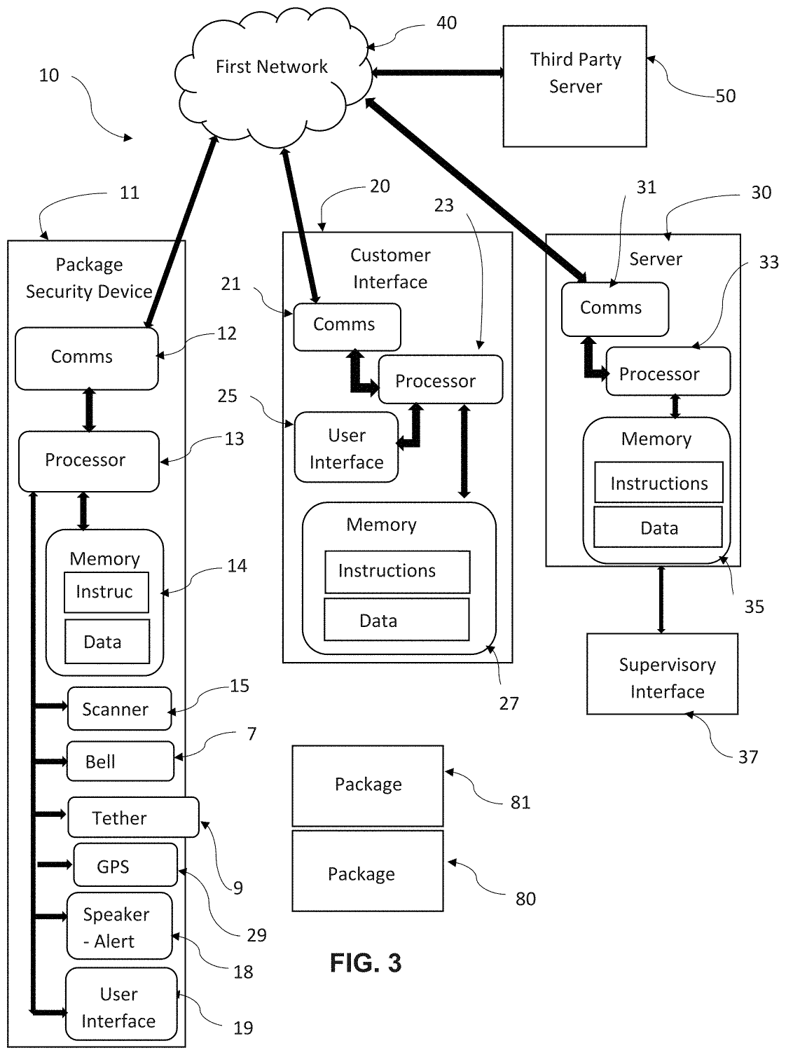

FIG. 3 illustrates a block diagram of an embodiment of system 10 for security of multiple packages 80, 81, according to one or more embodiments. This embodiment has all the elements described in the embodiments described with regard to FIG. 1. In some embodiments. the tether 9 is configured to secure package 80 and package 81. Package 80 may be delivered at Time A wherein the security device 11 is configured by the customer interface 20 to receive package 80 by providing instructions via the user interface 19 to the delivery person or device to scan the package code with the scanner 15. After the package code is scanned with the scanner 15, the package information is confirmed with instructions received from the customer interface 20 or the server 30. The user interface 19 then provides instructions to the delivery person or device including information as to where to place the package 80 such that the tether 9 is armed when attached to a physical tether 9 or a zone is turned on for a virtual tether 9. For the virtual tether 9, these instructions may include an image of the area in front of the security device 11 indicating a highlighted location for placing the package 80 (e.g., for optimal visualization via the one or more cameras 16, for optimal concealment if possible, clear line of sight, reduced physical interference, etc.). For the virtual tether 9, these instructions may also include projecting a zone onto the area in front of the security device 11 by using the strobe 17 or similar light source to highlight the area with a focused beam of light.

In one or more embodiments, for a physical tether 9, the instructions include the process for extending the tether 9 from the security device 11 and attaching it to the package 80. After the physical tether 9 is attached or the virtual tether 9 is armed, the instructions may include a notice on the user interface 19 or an alert (e.g., via an app on a smart device (e.g., smartphone, computing pad, etc.), email, text message, cellular message, a remote wireless device (e.g., a fob, remote control, etc.)) that confirms the tether 9 is armed and the package 80 is secured. The security device 11 may then receive additional instructions from the customer interface 20 regarding the delivery of a second package 81 at Time B, which is different from Time A. When package 81 is delivered, the user interface 19 on the security device 11 may provide instructions to the delivery person or device for scanning the package delivery label with the scanner 15. Once the scanned information is confirmed, the user interface 19 then provides instructions to the delivery person or device as to where the package 81 should be placed such that the tether 9 will be armed for both previously delivered package 80 and the new package 81.

In some embodiments, for a virtual tether 9, the instructions include an image of the area in front of the security device 11 indicating a highlighted location for placing the package 80. For the virtual tether 9, these instructions may also include projecting a zone onto the area in front of the security device 11 by using the strobe 17 or similar light source to highlight the area with a focused beam of light. The highlighted area may be adjacent the package 80, it may be on the top of the package 80 or one or more sides of the package 80. For a physical tether 9, the instructions may include the process for extending a second tether 9 from the security device 11 and attaching it to the package 80. After the one or more physical tethers 9 are attached or the one or more virtual tethers 9 are armed, the instructions may include a notice on the user interface or an alert (e.g., via an app on a smart device (e.g., smartphone, computing pad, etc.), email, text message, cellular message, a wireless remote device (e.g., a fob, remote control, etc.)) that confirms the tether 9 is armed and both packages 80 and package 81 are secured. In addition, the tether 9 may be a mat or platform and the user interface 19 may provide instructions to the delivery person or device to place package 81 adjacent to package 80, which was already on the mat/platform or on top of package 80 (already on the mat/platform). In either case, the mat/platform tether may detect the additional weight or mass of package 81 and transmit that data or information to the one or more processor devices 13, which then transmit instructions to the user interface 19 to display a notice that the packages where “Armed” and “Secure,” or provide an alert (e.g., via an app on a smart device (e.g., smartphone, computing pad, etc.), email, text message, cellular message, a wireless remote device (e.g., a fob, remote control, etc.)).

In one or more embodiments, the customer interface 20 or the user interface 19 may be used to define the location, size, and shape of the virtual tether 9 armed and secure zone. For example, the customer interface 20 or the user interface 19 may be used to define a very small area (e.g., 2 feet wide by 2 feet deep by 1 foot high virtual tether 9 zone that begins 2 feet in front of the security device 11) in order to arm and secure a package or object 80 that fits inside that zone that is planned for delivery. By defining a particular zone, the delivered package 80 can still be armed and secured, and any additional movement outside of that zone does not trigger an unauthorized movement event (e.g., an animal (e.g., a cat, a dog, etc.) walking by one foot outside the zone will not cause a trigger). The customer interface 20 or user interface 19 may be used to update or change the size of a defined virtual tether 9 zone in order to arm and secure a larger package 80 or for the planned delivery of additional packages on a particular day. In addition to defining a virtual tether 9 zone, the customer interface 20 or user interface 19 may also be used to define a larger movement detection zone outside of the virtual tether 9 zone. For example, a small 2 feet wide by 2 feet deep by 1 foot high virtual tether 9 zone that starts 2 feet in front of the security device 11 may be defined, and an additional 10 foot wide by 25 feet deep by 8 feet high movement detection zone may be defined that starts 4 feet in front of the security device 11. This movement detection zone may be used to detect movement outside of the virtual tether 9 zone, and that movement may cause a different set of actions by the security device 11. For example, the customer interface 20 or user interface 19 that was used to define the movement detection zone may also be used to set a low level visible (or strobe) alert 17 (FIGS. 1-2) and/or a low audible (or speaker) alert 18 and/or turn on the one or more cameras 16 to send video data to the customer interface 20. In this manner, the security device 11 provides both of the armed and secure functions for securing a package 80, as well as a notification and deterrence function related to an unauthorized person approaching the package 80.

In one or more embodiments, the security device 11 includes a bell or speaker 7. The bell or speaker 7 may be configured to activate the doorbell of the location where the security device 11 is located. The bell or speaker 7 may be connected to the doorbell either with a direct line wired or wirelessly. The use of a separate bell 7 to activate the doorbell of the location where the security device 11 is located provides one process for activating the doorbell. In one embodiment, the user interface 19 may be used to activate the doorbell. For example, the user interface 19 may include a touchscreen that is configured with a window or popup window with a virtual button or bell on it, that when pressed activates the location's doorbell. The user interface 19 may also include a microphone that detects the sound of arrival of a person or device and automatically activates the doorbell. Alternately the microphone may activate the doorbell after detecting the command “Ring the doorbell” that was spoken by the arriving person using NLU/NLP. In one embodiment, the one or more cameras 16 may be used to visually detect the arrival of a person or device to activate the doorbell.

In some embodiments, the security device 11 includes a global positioning sensor (GPS) receiver 29. The GPS receiver 29 is configured to receive data/information from at least one satellite network and to transfer that data/information to the one or more processor devices 13. The GPS data/information may be used to assist in locating the security device 11 by the third-party in order to efficiently deliver a package 80 to the correct location.

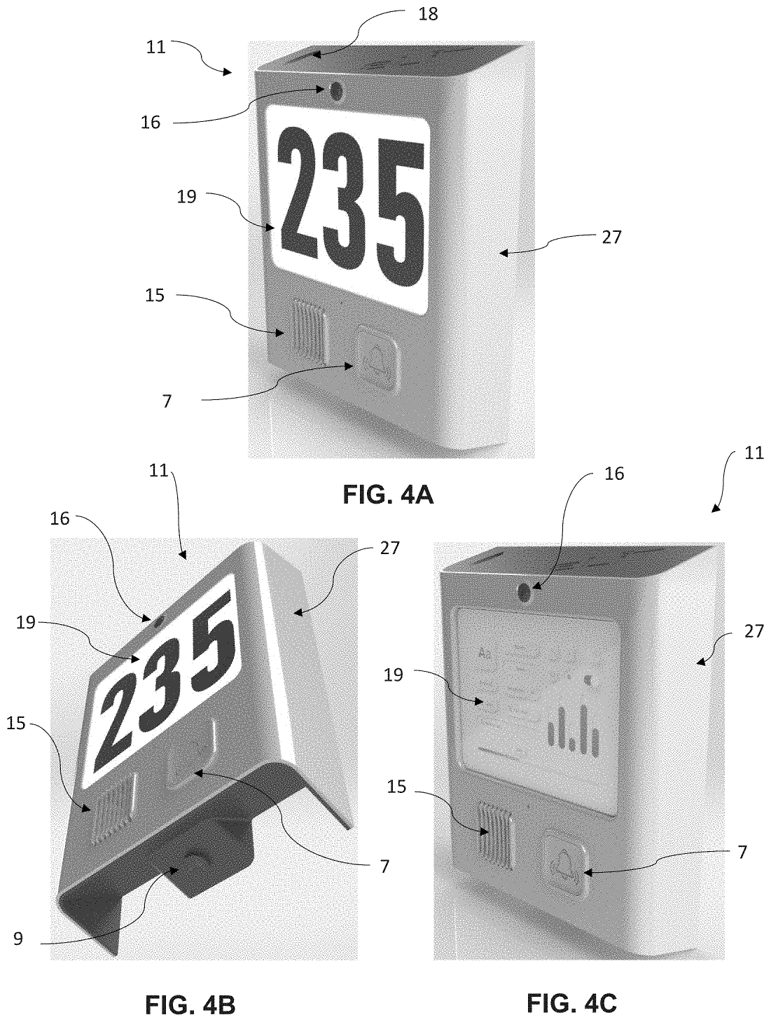

FIG. 4A shows a side perspective view of an example embodiment of the security device 11, according to one or more embodiments. FIG. 4B shows a bottom perspective view of an example embodiment of the security device 11, according to one or more embodiments. FIG. 4C shows a side perspective view of the security device 11 showing an example user interface 19 display, according to one or more embodiments. In FIG. 4A an example security device 11 is shown including a housing 27 with a user interface 19, a camera 16, a scanner 15 and a bell 7 on the front surface. The housing 27 includes a speaker or audible alarm 18 on the top surface. The user interface 19 is configured to display the address number of the location. By displaying the address number, the user interface 19 assists the delivery person or device in locating the correct delivery address. In FIG. 4B the bottom of the housing 27 is configured with a (physical) tether 9. With the security device 11 mounted on an exterior wall of a location, the tether 9 has a clear view of the ground surface in front of the security device 11 in order to secure packages placed on a surface in front of the security device 11.

In some embodiments, FIG. 4B shows a single tether 9. The security device 11 may also be configured with additional tethers 9 (e.g., 2, 3, 4, etc.), which may each be used to secure different packages. FIG. 4C shows the security device 11 with the user interface 19 showing a menu display of different options, adjustments, features, etc. The user interface 19 displays a wide variety of images and information, including but not limited to, the location address, the image captured by the camera 16, instructions for a delivery person to scan a package, instructions on how to arm the delivered package with either a physical or virtual tether 9, notification that a package is armed or secure, etc. The package or other physical object may be disarmed by the owner of the security device by either inputting disarm instructions via the customer interface 20 (FIGS. 1-3) or the user interface 19. The owner or authorized person may also send disarming instructions to the security device 11 to be displayed on the user interface 19 in order to enable a designated person that is authorized to disarm the package 80. In some embodiments, facial recognition may be employed in order to recognize authorized individuals or delivery persons, or to send an alert and image or video of any unrecognized individuals to the user.

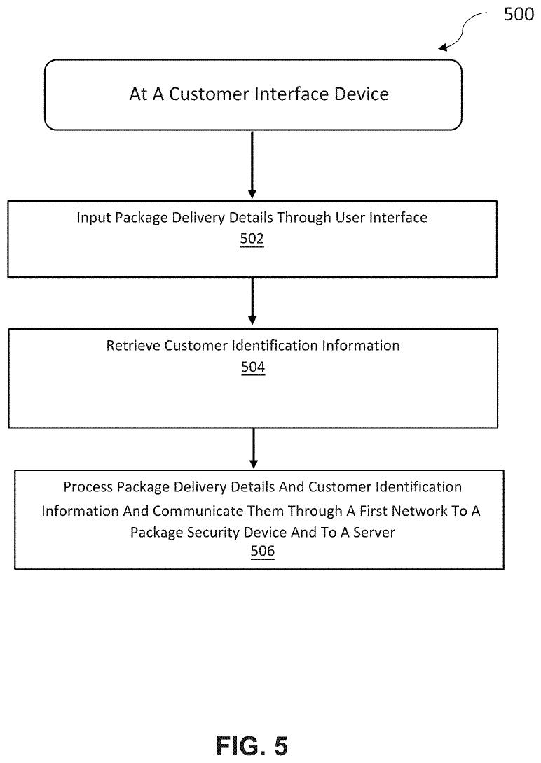

FIG. 5 shows an example process 500 for processing and transmitting data from a customer interface 20 (FIGS. 1-3) to both the security device 11 (FIGS. 1-4C) and a server 30, according to one or more embodiments. The process 500 may be performed at the customer interface 20 by processing logic that may include hardware (circuitry, dedicated logic, etc.), software, or a combination thereof. The process 500 and/or each of their individual functions, subroutines, or operations may be performed by one or more processors of the customer interface 20 (e.g., one or more processor devices 23 of FIG. 1) implementing the process 500. In some embodiments, the process 500 may be performed by a single processing thread. In one or more embodiments, the process 500 may be performed by two or more processing threads, each thread implementing one or more individual functions, routines, subroutines, or operations of the methods. In block 502, the process 500 provides that the customer interface 20 receives package delivery details (data/information) through a user interface 19 (FIGS. 1-3). The package delivery details may include delivery address information, special instructions, etc. The delivery address information may be input using the user interface 19 in the standard form for addresses in that location such as street number, street name, unit number, name of town, name of state or province, the address code such as a zip code, etc.

In some embodiments, the package delivery details may include the date and approximate time of the planned delivery. The package delivery details may further include delivery company information including the delivery company name and delivery company contact information. In one or more embodiments, the delivery driver or device details (e.g., type of vehicle or device, image of the driver, license plate information, etc.) may also be included in the package delivery details. The package delivery details may additionally include the number of packages being delivered, the relative size of the packages, the contents of the packages, the weight of the packages and any specific instructions to ensure secure delivery of the packages. In block 504, the process 500 provides that the customer interface 20 retrieves unique customer identification information that is stored on either internal or external memory (e.g., memory 27 of FIG. 1). The customer identification information may include customer first and last name, customer's mailing address, customer's email address, customer's phone number, customer password, unique identification number assigned to the customer at the time of purchase of the security device 11 or assigned after purchase of the security device 11 while registering the security device 11 with the manufacturer.

In some embodiments, in block 506 the process 500 provides that the delivery information and unique identification information are processed (e.g., using one or more processor devices 23, FIGS. 1-3) and transmitted through a network (e.g., the first network 40, FIGS. 1-3) by the comms 21 (FIGS. 1-3) to the server 30 (FIGS. 1-3) and the security device 11.

In one or more embodiment, for ease of explanation, the process 500 is depicted and described as a series of operations. However, operations in accordance with this disclosure may occur in various orders and/or concurrently, and/or with other operations not presented and described herein. For example, the operations depicted in the process 500 may occur in combination with any other operation of any other method disclosed herein. Furthermore, not all illustrated operations may be required to implement the process 500 in accordance with the disclosed subject matter. In addition, those skilled in the art will understand and appreciate that the process 500 could alternatively be represented as a series of interrelated states via a state diagram, a directed graph, a deterministic finite state automaton, a non-deterministic finite state automaton, a Markov diagram, or event diagrams.

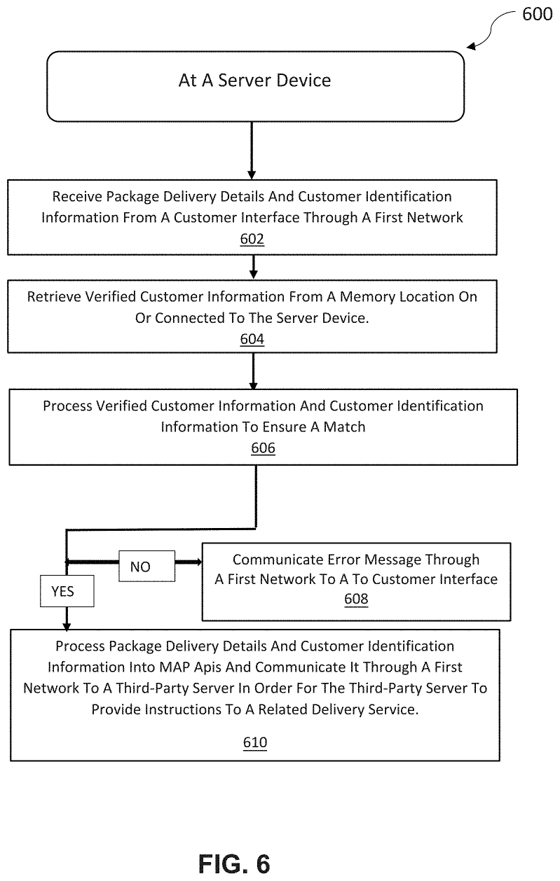

FIG. 6 shows an example embodiment of a process 600 for processing and transmitting data from a server 30 (FIGS. 1-3) to both a third-party server 50 (FIGS. 1-3) and a customer interface 20 (FIGS. 1-3), according to one or more embodiments. The process 600 may be performed by processing logic that may include hardware (circuitry, dedicated logic, etc.), software, or a combination thereof. The process 600 and/or each of its individual functions, subroutines, or operations may be performed by one or more processor devices 33 (FIGS. 1-3) of the server 30 (FIGS. 1-3) implementing the process 600. In some embodiments, the process 600 may be performed by a single processing thread. In one or more embodiments, the process 600 may be performed by two or more processing threads, each thread implementing one or more individual functions, routines, subroutines, or operations of the process 600. In block 602, the process 600 provides that a comms 31 (FIGS. 1-3) of the server 30 receives package delivery and customer identification information from the customer interface 20 (FIGS. 1-3) through the first network 40 (FIGS. 1-3).

In some embodiments, in block 604 the process 600 provides that the verified customer information that is stored on either internal or external memory (e.g., the memory 35, FIGS. 1-3 is retrieved. The retrieved verified customer information and the received customer identification information are then processed using the one or more processor devices 23 (FIGS. 1-3) to ensure a match. In block 606 the process 600 provides that if the two sets of information do not properly match, an error message or alert is generated by the one or more processor devices 23 sent to the comms 31 (FIGS. 1-3) and transmitted through the network 40 to the customer interface 20 in block 608. In block 610 the process 600 provides that if the two sets of information properly match, the package delivery information and customer identification information are processed by the one or more processor devices 23 into map application programming interfaces (APIs), sent to the comms 31 and transmitted through the network 40 to the third-party server 50.

In one or more embodiments, the map APIs may be utilized by the third-party server 50 to facilitate information to a delivery person for the safe and timely delivery of a package to the location of the security device 11. Similarly, to the blocks described for process 300, the operations depicted in the process 600 may occur in combination with any other operation of any other process disclosed herein. Furthermore, not all illustrated operations may be required to implement the process 600 in accordance with the disclosed subject matter. In addition, those skilled in the art will understand and appreciate that the process 600 could alternatively be represented as a series of interrelated states via a state diagram, a directed graph, a deterministic finite state automaton, a non-deterministic finite state automaton, a Markov diagram, or event diagrams.

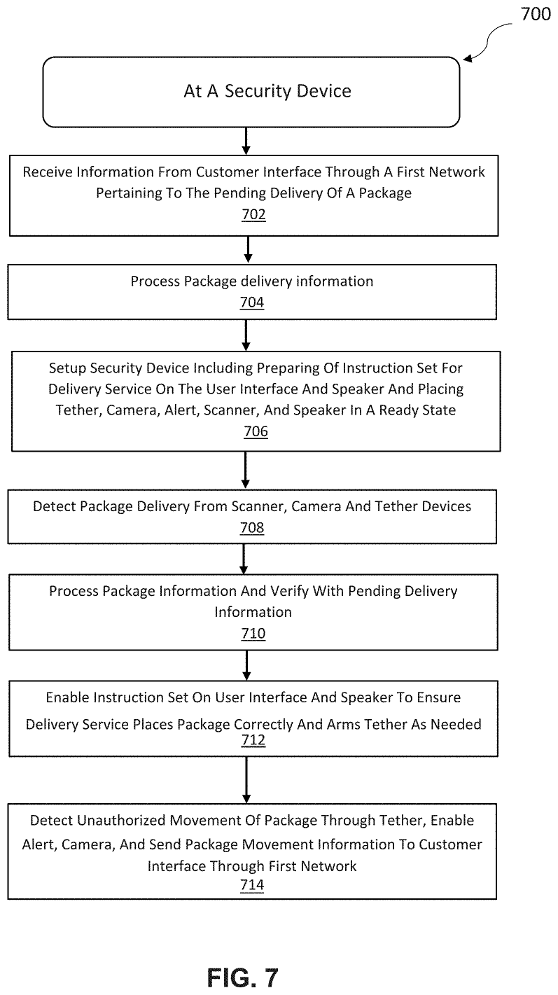

FIG. 7 shows an example embodiment of a process 700 for processing and transmitting data from the security device 11 (FIGS. 1-3) to both a delivery person and the customer interface 20 (FIGS. 1-3), according to one or more embodiments. In some embodiments, in block 702 of process 700 provides that the comms 12 (FIGS. 1-3) of the security device 11 receives package delivery information from the customer interface 20 through a network (e.g., the first network 40, FIGS. 1-3). In block 704 process 700 provides that a processor (e.g., one or more processor devices 13, FIGS. 1-3) processes the delivery information to properly setup the security device 11. In block 706 process 700 provides that the processor sets up the security device 11 by preparing package delivery instructions to be displayed on a user interface (e.g., user interface 19, FIGS. 1-3) and/or delivered by an audio speaker (e.g., speaker 18, FIGS. 1-3) and also by placing a tether (e.g., tether 9 (physical, virtual or both, FIGS. 1-3), a camera (e.g., one or more cameras 16 of FIGS. 1-3), a scanner (e.g., scanner 15, FIGS. 1-3), and an alert (e.g., strobe 17, FIGS. 1-2) in a ready state.

In some embodiments, in block 708 the process 700 provides that a package delivery is detected by one or more of the scanner, the camera, or a tether. In block 710 the process 700 provides that the processor processes the delivered package information and verifies it against the previously received pending delivery information, which may be retrieved from a memory location (e.g., the memory 14, FIGS. 1-3). If the information is verified, then in block 712 of the process 700, the processor enables the delivery instructions on the user interface and/or delivered by the audio speaker to ensure the package is placed correctly. After the package is place correctly, the tether is armed to detect further unauthorized movement of the package. In block 714 the process 700 provides that a tether detects unauthorized movement of the package and sends that information to the processor, which enables an alert (e.g., speaker-alert 18, strobe 17, FIGS. 1-2, the camera, via an app on a smart device (e.g., smartphone, computing pad, etc.), email, text message, cellular message, a wireless remote device (e.g., a fob, remote control, etc.)).

In one or more embodiments, the processor also sends information of the unauthorized movement including data from a camera and/or microphone to a communication module (e.g., communication module 12 of FIG. 1) which transmits the information through the network to the customer interface. In this manner, process 700 provides immediate information to the owner of the security device 11 of the unauthorized movement of a delivered package. The security device 11 may also be configured to send information of the unauthorized movement of the package including a video feed directly to the local authorities to enable the timely identification and apprehension of the person (or device) moving or taking the package.

In some embodiments, in process 700 the customer interface or user interface may also be used to define what unauthorized movement of the package entails. In one example embodiment, the package may be a paper bag of groceries or a small and light weight bubble wrap envelope. In this example, a breeze may cause one or more small movements of the package that would not be classified as unauthorized, and the owner of the security device 11 would not want a notification or alarm to be triggered. In one or more embodiments, the customer interface or user interface may be used to define unauthorized movement as the package 80 moving a particular distance, such as more than 2 inches in any direction, more than 4 inches in any direction, etc.

In one or more embodiments, the customer interface or user interface may also be used to define how long after scanning a package label or receiving an RFID of a package before the virtual tether is armed. In some embodiments, the customer interface or user interface may be used to define how long after placing the package in the virtual tether zone before the virtual tether is armed. In one example embodiment, if multiple packages are being delivered, the time between scanning the first package and arming the virtual tether may be set for 2 minutes, for 3 minutes, etc., to allow all the packages to be scanned and placed before arming the virtual tether.

In some embodiments, through a combination of the processes 500, 600 and 700 (FIGS. 5-7) as described herein, the security device 11, customer interface 20, and server 30 of the system 10 provide secure authorized and location precise contact-less (for virtual tether 9) or minimal contact (for physical tether 9) delivery by third parties of one or more delivery packages. The system 10 may be used in this manner to deter package theft. The system 10 may also be used in this manner to assist in the identification and apprehension related to package theft. The system 10 may also be used in this manner to assist in the accurate delivery of packages to the intended location. The processes 500, 600 and 700 also provide enhanced notification to a customer of the delivery of a package as well as the unauthorized movement of a package that has been delivered. The processes 500, 600 and 700 may also provide enhanced notification to a third-party of the delivery of a package as well as the unauthorized movement of a package that has been delivered. For example, a third-party delivery service can opt-in to the system 10 data network subscription so that the third-party can receive notification from the system 10 through a first network 40 of the successful delivery and/or successful delivery and arming of one or more packages. The third-party may also be notified by the security device 11 of unauthorized movement of the delivered and armed package(s) through the first network 40 to a third-party server 50.

In one or more embodiments, the process of securing packages and deterring package theft can be helpful in many different situations. For example, when accurately delivering a package to a particular apartment in a large apartment complex, the apartment location in many mapping locations is shown as just the front door of the apartment building. The actual location of the individual apartment is often not designated with more precision than the front entrance. This can be of even more importance when there are numerous buildings in an apartment complex. Using the system 10 (FIGS. 1-3) allows the delivery person to ensure proper delivery location. Similarly, a mall often shows every business address located in the mall at a single location when each individual business has its own unique location in the mall. Using the system 10 embodiments may assist both residential customers and business customers to provide more accurate and secure locations so that friends, delivery services, emergency management services, and customers can all find the residential and or business location for faster deliveries.

In some embodiments, the system 10 (FIGS. 1-3) may also be useful for locations that do not have a designated address, such as a location that is still under development or a location that is under redevelopment. During large construction projects such as residential or commercial development or redevelopment it is still important for suppliers to quickly find the current location in the development site and deliver the requested supplies safely. The system 10 described herein may be very helpful in directing suppliers, workers, inspectors, visitors, etc. to the desired location or locations in the development site. Similarly many rural locations and many locations in under-developed countries do not have detailed and specified addresses or secure delivery features. The system 10 embodiments can be helpful in directing friends, delivery services, emergency responders, customers and the like to rural locations and locations in countries and jurisdictions that do not have a detailed and specific address system or secure delivery locations.

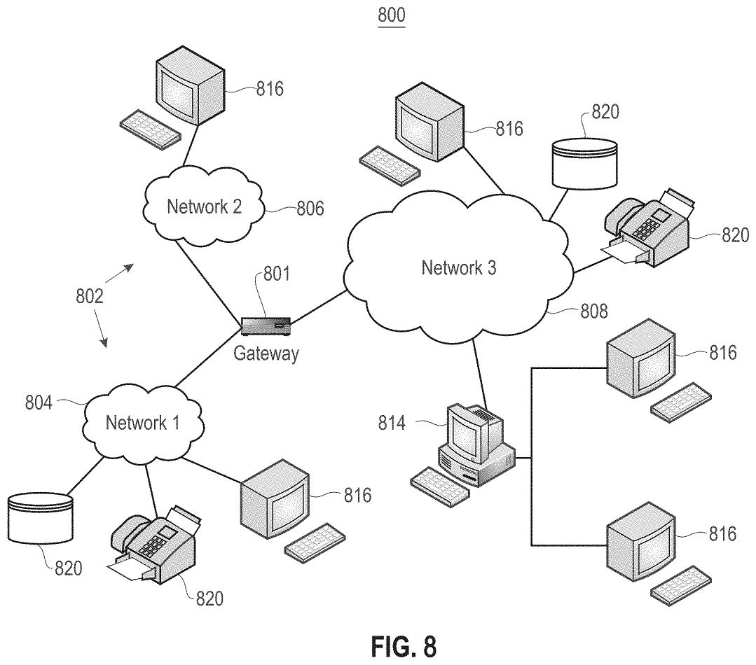

FIG. 8 is a network architecture of a system 800 for security processing, according to one or more embodiments. As shown in FIG. 8, a plurality of remote networks 802 are provided, including a first remote network 804 and a second remote network 806. A gateway 801 may be coupled between the remote networks 802 and a proximate network 808. In the context of the present network architecture 800, the networks 804, 806 may each take any form including, but not limited to, a LAN, a WAN, such as the Internet, public switched telephone network (PSTN), internal telephone network, etc.

In use, the gateway 801 serves as an entrance point from the remote networks 802 to the proximate network 808. As such, the gateway 801 may function as a router, which is capable of directing a given packet of data that arrives at the gateway 801, and a switch, which furnishes the actual path in and out of the gateway 801 for a given packet.

Further included is at least one data server 814 coupled to the proximate network 808, which is accessible from the remote networks 802 via the gateway 801. It should be noted that the data server(s) 814 may include any type of computing device/groupware. Coupled to each data server 814 is a plurality of user devices 816. Such user devices 816 may include a desktop computer, laptop computer, handheld computer, printer, and/or any other type of logic-containing device. It should be noted that a user device 816 may also be directly coupled to any of the networks in some embodiments.

A peripheral 820 or series of peripherals 820, e.g., facsimile machines, printers, scanners, hard disk drives, networked and/or local storage units or systems, etc., may be coupled to one or more of the networks 804, 806, 808. It should be noted that databases and/or additional components may be utilized with, or integrated into, any type of network element coupled to the networks 804, 806, 808. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WINDOWS® environment, a MICROSOFT® WINDOWS® system that emulates an IBM® z/OS environment, etc. This virtualization and/or emulation may be implemented through the use of VMWARE® software in some embodiments.

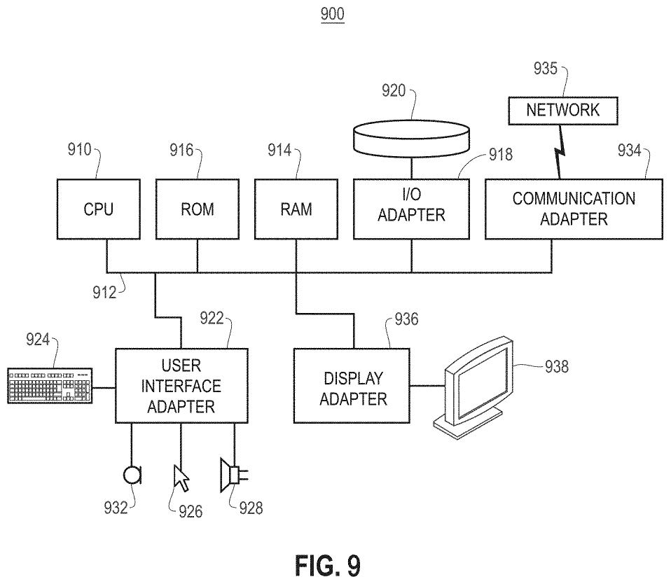

FIG. 9 shows a representative hardware system 900 environment associated with a user device 816 and/or server 814 of FIG. 8, in accordance with one embodiment. In one example, a hardware configuration includes a workstation having a central processing unit 910, such as a microprocessor, and a number of other units interconnected via a system bus 912. The workstation shown in FIG. 9 may include a Random Access Memory (RAM) 914, Read Only Memory (ROM) 916, an I/O adapter 918 for connecting peripheral devices, such as disk storage units 920 to the bus 912, a user interface adapter 922 for connecting a keyboard 924, a mouse 926, a speaker 928, a microphone 932, and/or other user interface devices, such as a touch screen, a digital camera (not shown), etc., to the bus 912, communication adapter 934 for connecting the workstation to a communication network 935 (e.g., a data processing network) and a display adapter 936 for connecting the bus 912 to a display device 938.

In one example, the workstation may have resident thereon an operating system, such as the MICROSOFT® WINDOWS® Operating System (OS), a MAC OS®, a UNIX® OS, etc. In one embodiment, the system 900 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

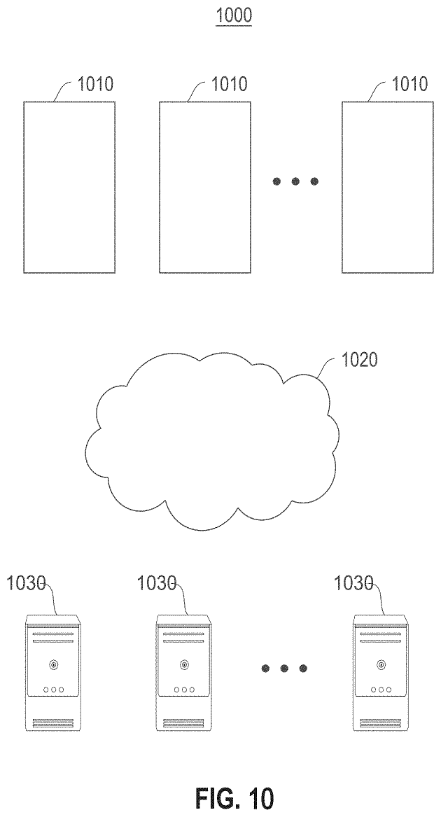

FIG. 10 is a block diagram illustrating a distributed system 1000 that may be employed for security processing, according to one or more embodiments. In one embodiment, the system 1000 includes client devices 1010 (e.g., mobile devices, smart devices, computing systems, etc.), a cloud or resource sharing environment 1020 (e.g., a public cloud computing environment, a private cloud computing environment, a data center, etc.), and servers 1030. In one embodiment, the client devices are provided with cloud services from the servers 1030 through the cloud or resource sharing environment 1020.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of pre-AIA 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A security device comprising:
a memory device including instructions;
at least one processor configured for executing the instructions to:
receive images of at least one physical object from at least one camera coupled to the at least one processor;
receive an indication from at least one security tether indicating movement of the at least one physical object; and
provide an alert based on the indication of movement of the at least one physical object.

2. The security device of claim 1, wherein the at least one security tether is at least one physical security tether device coupled to the at least one processor.

3. The security device of claim 2, wherein the at least one physical security tether includes an attachment element that is configured to removably couple with the at least one physical object.

4. The security device of claim 1, wherein the at least one security tether is generated as a virtual security tether process using imaging of the at least one camera or data from at least one motion sensor, the virtual security tether process detects movement of the at least one physical object, and the alert comprises one of an audio alert, a visual alert, or a combination thereof.

5. The security device of claim 4, wherein the at least one physical object comprises at least one of a delivery package, a personal item, an entry door, an entry gate, or a combination thereof, and information received for the at least one physical object is used for indications of a delivery.

6. The security device of claim 1, wherein the alert comprises one of an email alert, a text message alert, a doorbell alert, or a combination thereof.

7. The security device of claim 1, wherein the at least one processor is further configured for executing the instructions to receive information for the at least one physical object using a scanner device coupled to the at least one processor.

8. The security device of claim 7, wherein the scanner device is one of: configured for reading a printed code, a radio frequency identification (RFID) receiver, or a combination thereof.

9. The security device of claim 1, further comprising a communication component coupled to the at least one processor, wherein the communication component receives information of a pending delivery from a customer interface or a server, and the information of the pending delivery provides visible and audible guidance to a delivery person or device for a timely and accurate delivery of the at least one physical object.

10. The security device of claim 4, wherein the at least one camera comprises at least one fixed camera device, at least one portable camera device, or a combination thereof, the at least one portable camera device is configured for providing a visual security zone of the at least one physical object for the at least one virtual security tether process, and the fixed camera device and the at least one portable camera device are each configured for recording activation upon detection of motion or movement of the at least one physical object.

11. A security device system comprising:
a security device including:
a first memory device including first instructions;
a first processor configured for executing the first instructions to:
receive images of the at least one physical object from at least one camera coupled to the first processor;
receive an indication from at least one security tether indicating movement of the at least one physical object; and
provide an alert based on the indication of movement of the at least one physical objects;
a customer interface including:
a second memory device including second instructions;
a second processor configured for executing the second instructions to:
receive delivery details information;
retrieve customer identification information;
process the delivery details and customer identification information; and
communicate the delivery details and the customer identification information through a first network to the security device and to a server.

12. The security device system of claim 11, wherein the at least one security tether is a physical security tether device coupled to the first processor, and the physical security tether includes an attachment element that is configured to removably couple with the at least one physical object.

13. The security device system of claim 11, wherein the at least one security tether is generated as a virtual security tether process using imaging of the at least one camera or data from at least one motion sensor, and the virtual security tether process detects movement of the at least one physical object.

14. The security device system of claim 11, wherein the alert comprises one of an audio alert, a visual alert, or a combination thereof, and the at least one physical object comprises at least one of a delivery package, a personal item, an entry door, an entry gate, or a combination thereof.

15. The security device system of claim 11, wherein the alert comprises one of an email alert, a text message alert, a doorbell alert, or a combination thereof.

16. The security device system of claim 11, wherein the security device further comprises a communication component coupled to the first processor, and the communication component receives information of a pending delivery from the customer interface or the server.

17. The security device system of claim 16, wherein the information of the pending delivery provides visible and audible guidance to a delivery person or device for a timely and accurate delivery of the at least one physical object.

18. The security device system of claim 13, wherein the at least one camera comprises at least one of a fixed camera device, at least one portable camera device, or a combination thereof, and the at least one portable camera device is configured for providing a visual security zone of the at least one physical object for the at least one virtual security tether process.

19. The security device system of claim 18, wherein the fixed camera device and the at least one portable camera device are each configured for recording activation upon detection of motion or movement of the at least one physical object.

20. The security device system of claim 11, wherein:
the first processor is further configured for executing the first instructions to:
receive information for the at least one physical object using a scanner device coupled to the first processor; and
the scanner device is one of: configured for reading a printed code, a radio frequency identification (RFID) receiver, or a combination thereof.
